(19) United States
(12) Patent Application Publication
(10) Pub. No.: US 2007/0200485 A1
(43) Pub. Date: Aug. 30, 2007

(54) Image display device

(76) Inventors: Tomio Yaguchi, Sagamihara (JP); Tetsuya Yamazaki, Fujisawa (JP); Takahiko Muneyoshi, Musashimurayama (JP); Makoto Okai, Tokorozawa (JP); Susumu Sasaki, Chiba (JP); Jun Ishikawa, Mobara (JP); Nobuaki Hayashi, Kunitachi (JP)

Correspondence Address: REED SMITH LLP, Suite 1400, 3110 Fairview Park Drive, Falls Church, VA, 22042, US

(21) Appl. No.: 11/513,261

(22) Filed: Aug. 31, 2006

(30) Foreign Application Priority Data
Sep. 5, 2005 (JP) 2005-256500

(51) Int. Cl. H01J 1/62

(52) U.S. Cl. 313/496

(57) ABSTRACT

In an image display device that utilizes field emission and has electron sources made of carbon nanotube or the like, a break attributable to a wiring pattern of thin lines is controlled. Cathode spots and cathode lines are formed independently of each other so that even if one cathode spot is broken, all the cathode lines may become defective. Specifically, each of the cathode spots includes an electron emission layer and a cathode base bearing the electron emission layer. The cathode lines are formed separately. Each cathode spot is electrically coupled to a cathode line via a cathode branchline. Owing to the structure, even if part of the electron emission layer is broken, the other part thereof coupled to the cathode lines will not be adversely affected.

### CLAIM OF PRIORITY

The present application claims priority from Japanese Application JP 2005-256500 filed on Sep. 5, 2005, the content of which is hereby incorporated by reference into this application.

### FIELD OF THE INVENTION

The present invention relates to an image display device including cathode spots from which electrons are emitted with application of an electric field, and a fluorescent screen that is excited with the electrons emitted from the cathode spots. More particularly, the present invention is concerned with an image display device that avoids occurrence of a display defect derived from a break of any of lines, which are formed according to a printing method, occurring during a baking process. The present invention is preferably adapted to a flat-panel image display device whose cathode from which electrons are emitted with application of a low electric field is made of a carbonic material such as carbon nanotube, fine carbon fibers, or diamond.

### BACKGROUND OF THE INVENTION

Emissive materials such as diamond and carbon nanotube (CNT) that exhibit satisfactory electron emission responsively to application of a feeble electric field that is feebler than an electric field required by a field emission cathode made mainly of a conventional metallic material have been exploited. Plural cathode spots made of such an emissive material is formed like a matrix in a first substrate. The first substrate is bonded to a second substrate, in which phosphor dots and an anode are formed, in order to form a vacuum container, whereby an image display device is produced as a field-emission image display device.

This type of image display device is known to have cathode spots and neighboring control electrodes arranged in the form of a matrix in a main surface that is one of the surfaces of a first substrate referred to as a back substrate or a cathode substrate. Phosphor dots arrayed in the form of a matrix in line with the matrix of cathode spots, and an anode are formed in a main surface that is one of the surfaces of a second substrate referred to as a front substrate or a phosphor substrate. Herein, electrons emitted from the cathode spots are controlled by the control electrodes, and accelerated with an acceleration voltage applied to the anode. This excites the phosphor spots. Light emitted from each of the phosphor dots is used to display an image.

Patent Documents 1 and 2 have disclosed such image display devices in which cathode spots and control electrodes are disposed on the same plane parallel to the main surface of the first substrate (in-plane-gate (IPG) structure). Patent Document 3 has disclosed an image display device in which a wide bus is adopted in consideration of the distribution of wiring resistances at cathode spots.

[Patent Document 1] Japanese Patent Laid-Open No. 2002-25478

[Patent Document 2] Japanese Patent Laid-Open No. 2004-5186219

[Patent Document 3] Japanese Patent Laid-Open No. H11-185677

### SUMMARY OF THE INVENTION

For example, a paste containing a conductive material such as silver is used to print the wiring that interconnects cathode spots at which an electron emission layer is made of carbon nanotube (CNT), and the printed wiring is baked in order to form thin wiring. For example, concerning the IPG structure, a silver paste is used to print a pattern of lines, which are 30 μm in width, from the viewpoint of a driving voltage. When the printed pattern of thin lines is baked in order to complete a wiring pattern, the print layer may contract to cause a break. According to the ongoing structure including cathode spots, a cathode also serves as cathode feeder lines (cathode lines). Therefore, if a break occurs in the printed pattern, power is not fed to cathode spots succeeding the break spot. Consequently, electronic emission is not achieved any longer. This results in plural defective pixels (display defects).

The present invention is intended to provide an image display device that is free from a terrible display defect because occurrence of a break derived from adoption of a wiring pattern of thin lines is prevented.

According to the present invention, (1) each of cathode spots is composed of an electron emission layer and a cathode base bearing the electron emission layer, cathode lines are formed separately, and each of the cathode spots is electrically coupled to a cathode line over a cathode branch line. Moreover, according to the present invention, the width of the cathode lines is larger than that of the cathode bases. Furthermore, according to the present invention, each of the cathode bases is electrically coupled to a cathode line over plural paths. According to the present invention, each of the cathode bases has a portion whose tensile strength is lower and which is liable to rupture.

Since the cathode lines are included independently of the cathode spots, even if any of the cathode spots is broken, electron emission is normally achieved at pixel locations (or, simply, pixels) other than a pixel realized with the cathode spot. Consequently, occurrence of a terrible display defect is avoided. Moreover, since the width of the cathode lines is larger than that of the cathode bases, the probability of occurrence of a break of a cathode line that affects a larger number of pixels can be minimized. Furthermore, since each of the cathode bases is electrically coupled to a cathode line over plural paths, as long as the number of breaks occurring among nodes is equal to or smaller than an estimated number of breaks, the coupling to all the cathode spots can be satisfactorily sustained. Each of the cathode bases is artificially provided with a portion that is liable to break and that is formed in a region whose break is permissible. The permissible break alleviates a tensile stress and helps prevent an unexpected break from occurring in the other portion.

According to the present invention, since a pixel that becomes defective is only a pixel at which a break has occurred, deterioration in image quality derived from occurrence of the defect can be minimized. Moreover, the cross-sectional area of each cathode line can be increased without being restricted by a driving voltage affected by the width of each cathode spot. Consequently, a break hardly occurs. Moreover, an electrical resistance can be decreased. Eventually, not only reliability but also responsiveness can be improved.

According to the present invention, as long as the number of breaks that have occurred is equal to or smaller than the estimated number of breaks, electrical couplings among the cathode lines and the cathode spots are left unaffected. Occurrence of a detective pixel can be suppressed. As a result, deterioration in image quality can be prevented and a yield can be improved.

According to the present invention, since a break occurs in a portion where occurrence of a break is predicted, measures can be readily taken against occurrence of the break and a yield can be readily improved. Consequently, a cost of manufacture can be reduced. Moreover, since a break occurs in a portion where occurrence of a break is permitted, occurrence of a break in a portion where the occurrence is not permitted can be suppressed. Eventually, a yield can be improved.

### BRIEF DESCRIPTION OF THE DRAWINGS

FIG. 1 is a perspective view showing an electron emission structure formed in the main surface of a back substrate for the purpose of explaining the first embodiment of the present invention;

FIG. 2 is a plan view showing a cathode spot shown in FIG. 1;

FIG. 3 is a cross-sectional view showing an A-A′ cutting plane indicated in FIG. 1;

FIG. 4 is a perspective view showing an electron emission structure formed in the main surface of a back substrate for the purpose of explaining the second embodiment of the present invention;

FIG. 5 is a plan view showing two cathode spots juxtaposed along a cathode line shown in FIG. 4;

FIG. 6 is a cross-sectional view showing an A-A′ cutting plane indicated in FIG. 4;

FIG. 7 is a cross-sectional view showing a B-B′ cutting plane indicated in FIG. 4;

FIG. 8 is a perspective view showing an electron emission structure formed in the main surface of a back substrate for the purpose of explaining the third embodiment of the present invention;

FIG. 9 is a plan view showing a cathode spot shown in FIG. 8;

FIG. 10 is a cross-sectional view showing an A-A′ cutting plane indicated in FIG. 8;

FIG. 11 is a cross-sectional view showing a B-B′ cutting plane indicated in FIG. 8;

FIG. 12 is a plan view showing a major portion for the purpose of explaining the fourth embodiment of the present invention;

FIG. 13 is an explanatory diagram concerning alleviation of stresses imposed on a node among a cathode line and cathode branch lines which are shown in FIG. 12;

FIG. 14 is a perspective view showing an electron emission structure formed in the main surface of a back substrate for the purpose of explaining the fifth embodiment of the present invention;

FIG. 15 is a plan view showing only a cathode spot shown in FIG. 14 in enlargement;

FIG. 16 is a cross-sectional view showing only a cathode spot in a back substrate in enlargement for the purpose of explaining the sixth embodiment of the present invention;

FIG. 17 is a cross-sectional view showing only a cathode spot in a back substrate, which corresponds to the one shown in FIG. 16, for the purpose of explaining the seventh embodiment of the present invention;

FIG. 18 is a cross-sectional view showing only a cathode spot in a back substrate, which corresponds to the one shown in FIG. 17, for the purpose of explaining the eighth embodiment of the present invention;

FIG. 19 is a perspective cutaway showing the overall structure of a display device realizing an image display device in accordance with the present invention;

FIG. 20 is a cross-sectional view showing an A-A′ cutting plane indicated in FIG. 19; and P FIG. 21 is a partial cross-sectional view showing an example of the structure of a face substrate shown in FIG. 19.

### DESCRIPTION OF THE PREFERRED EMBODIMENTS

Referring to the drawings, embodiments of the present invention will be described below. Noted is that dimensions presented in a description of embodiments are exemplary values.

### First Embodiment

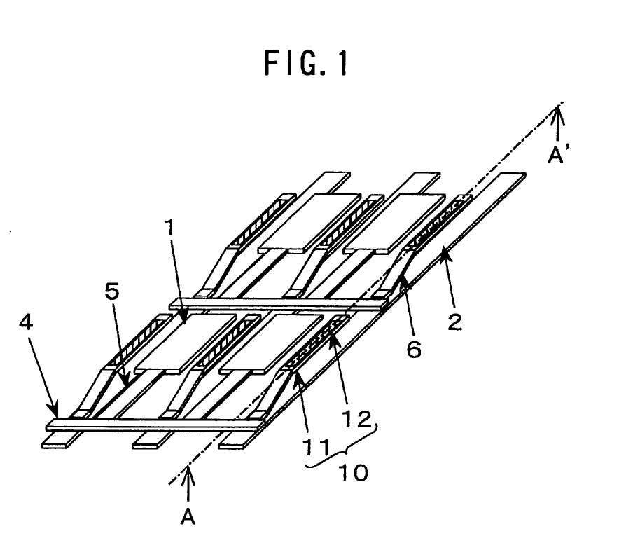

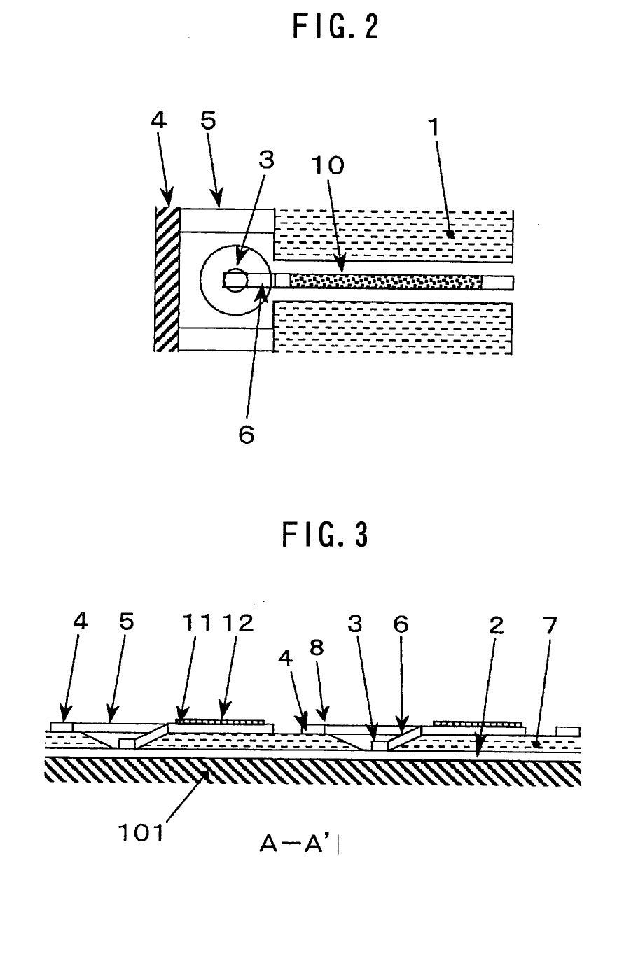

FIG. 1 is a perspective view showing an electron emission structure formed in the main surface of a back substrate for the purpose of explaining the first embodiment of the present invention. FIG. 2 is a plan view showing a cathode spot shown in FIG. 1. FIG. 3 is a cross-sectional view showing an A-A′ cutting plane indicated in FIG. 1. A back substrate is not shown in FIG. 1. In FIG. 1 to FIG. 3, numerous cathode lines 2 coupled to a data signal line drive circuit that is not shown are juxtaposed uni-directionally in the main surface of the back substrate. As indicated with a circle in FIG. 2, a cathode base 11 is electrically coupled to a cathode line 2 via a cathode branch line 6 at one cathode node 3. An electron emission layer 12 is formed on the cathode bases 11. Herein, the cathode base 11 and electron emission layer 12 shall constitute a cathode spot 10.

Plural gate lines (control electrode lines) 4 insulated by an insulating layer 7 are juxtaposed while intersecting the cathode lines 2. Control electrodes (gate electrodes) 1 are coupled to each of the gate lines 4 via respective gate branch lines 5 at respective gate nodes 8. The control electrodes 1 are disposed so that they will be flush with the cathode spots 10 and every pair of control electrodes 2 will sandwich each cathode spot 10.

The electrodes and electrode lines are formed by applying and baking a silver paste. The electron emission layer 12 is formed after the cathode bases are baked. The cathode lines are wider than the cathode bases 11. Preferably, the cathode bases 11 should be as thinner as possible so that an electric field induced by each of the control electrodes 1 will efficiently act on electrons emitted from the electron emission layer 12. However, as the cathode bases 11 get thinner, the probability that the cathode bases may rupture due to contraction occurring during a baking process gets higher.

In the first embodiment, the cathode spots 10 are formed independently of the cathode lines. Consequently, a break occurring in any of the cathode spots is limited to the pixel concerned and does not affect the other pixel locations.

### Second Embodiment

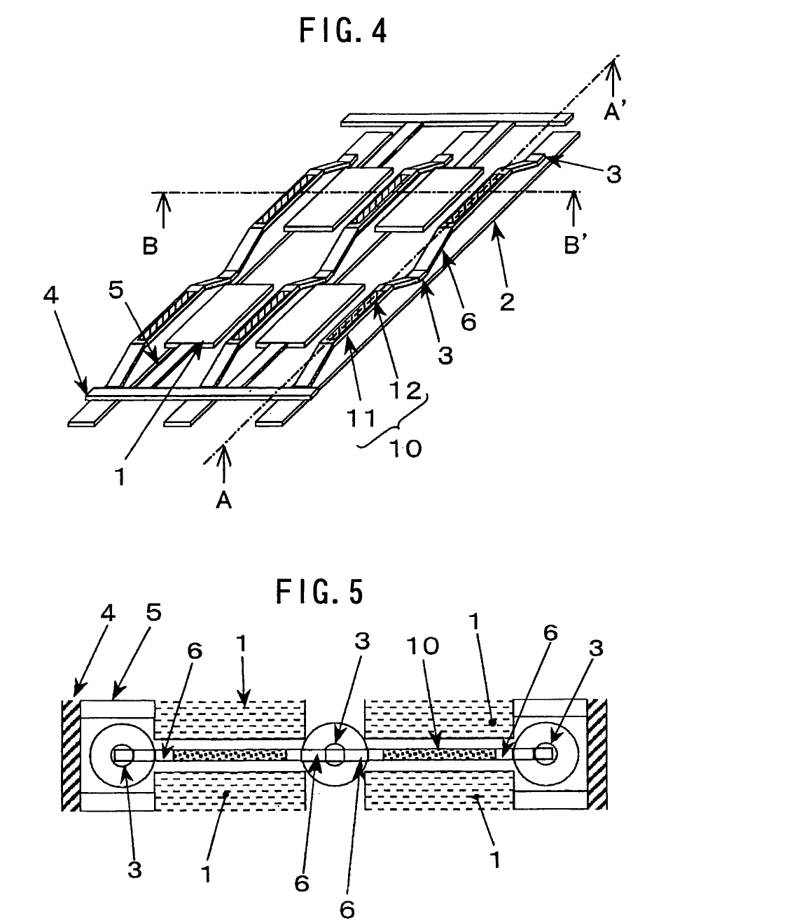

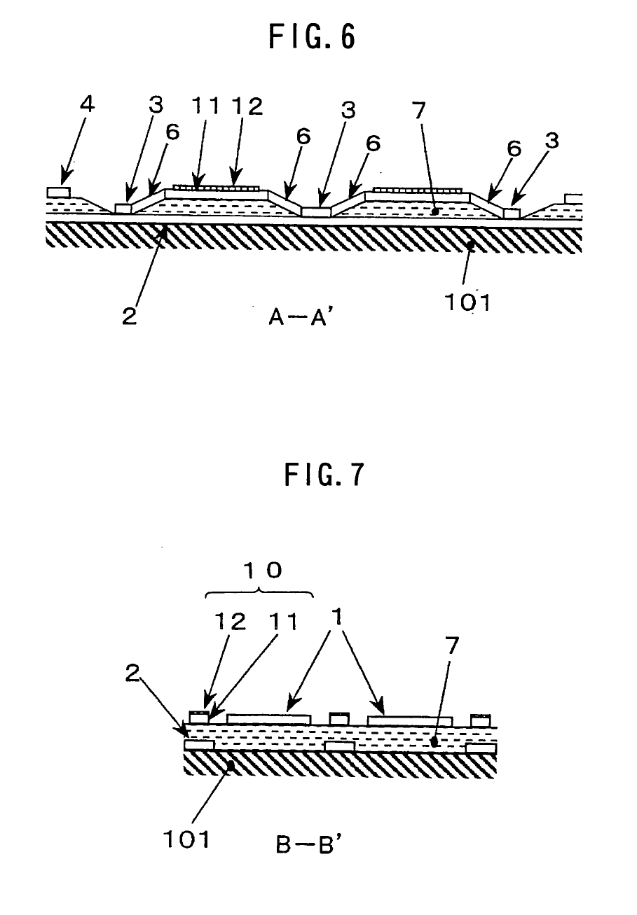

FIG. 4 is a perspective view showing an electron emission structure formed in the main surface of a back substrate for the purpose of explaining the second embodiment of the present invention. FIG. 5 is a plan view showing two cathode spots juxtaposed along a cathode line shown in FIG. 4. FIG. 6 is a cross-sectional view showing an A-A′ cutting plane indicated in FIG. 4. FIG. 7 is a cross-sectional view showing a B-B′ cutting plane indicated in FIG. 4. FIG. 4 does not show a back substrate. Moreover, the same reference numerals are assigned to components identical to those shown in FIG. 1 to FIG. 3.

The second embodiment is characterized in that the cathode base 11 included in each cathode spot 10 is electrically coupled to a cathode line 2 at two cathode nodes 3. The other constituent features are identical to those of the first embodiment. FIG. 7 shows the cathode spots 10 each of which is sandwiched between the gates 1 flush with the cathode spots. In the present embodiment, each of the cathode spots 10 is coupled to a cathode line at the cathode nodes 3 via respective cathode branch lines 6 extending in the longitudinal directions from the ends of the cathode spot 10. The present invention is not limited to this structure. Alternatively, each of the cathode spots 10 may be electrically coupled to a cathode line by extending two, three, or more cathode branch lines from any points of a cathode base.

As mentioned above, according to the second embodiment, plural feeder paths is formed between each cathode spot and a cathode line. Therefore, even if some breaks occur at a cathode spot, as long as the number of breaks is equal to or smaller than an estimated number of breaks, a current can be fed to the electron emission layer through the cathode lines. A defective pixel will not ensue.

### Third Embodiment

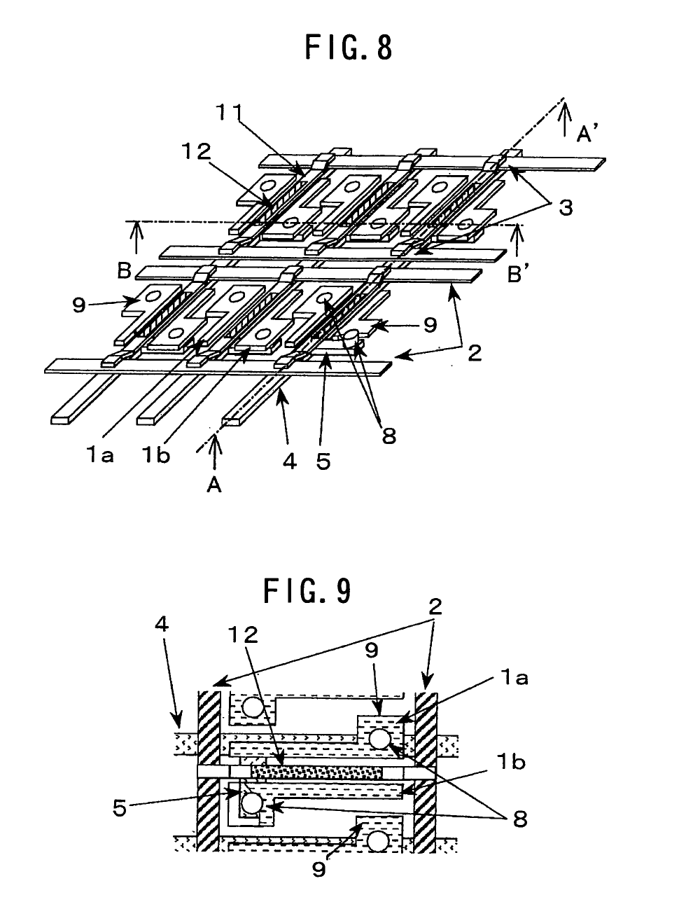

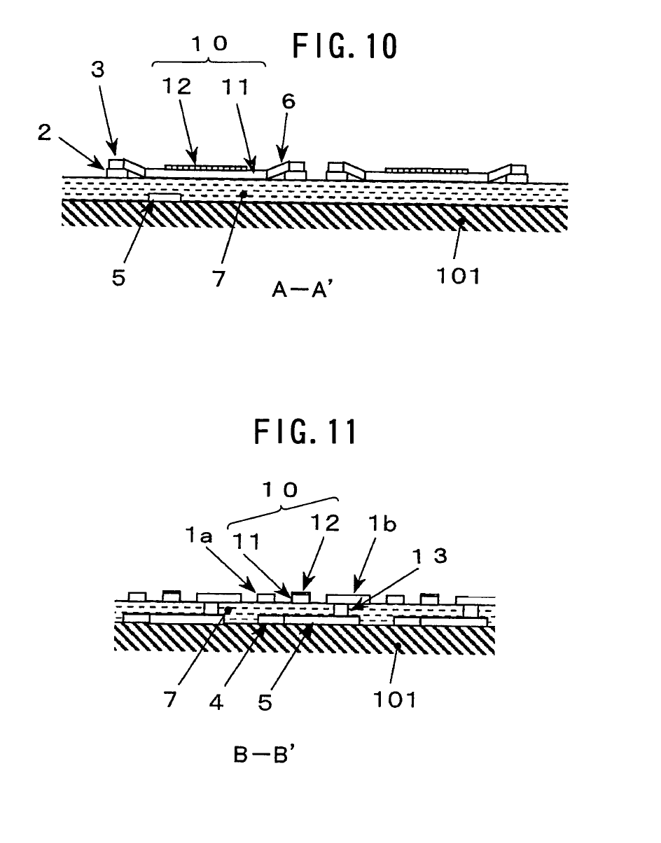

FIG. 8 is a perspective view showing an electron emission structure formed in the main surface of a back substrate for the purpose of explaining the third embodiment of the present invention. Moreover, FIG. 9 is a plan view showing a cathode spot shown in FIG. 8. FIG. 10 is a cross-sectional view showing an A-A′ cutting plane indicated in FIG. 8. FIG. 11 is a cross-sectional view showing a B-B′ cutting plane indicated in FIG. 8. FIG. 8 does not show the back substrate. Moreover, the same reference numerals are assigned to components identical to those shown in FIG. 1 to FIG. 7.

In the third embodiment, gate lines 4 are formed in the main surface of a back substrate 101, and cathode spots 10 are formed on the gate lines 4 with an insulating layer 7 between them. Each of the gate lines 4 has a gate branch line 5, which is formed in the same layer as the gate lines are formed, coupled thereto. The cathode lines 2 and cathode bases 11 are formed on the insulating layer 7. The electron emission layer 12 is formed over the surfaces of the cathode bases 11, whereby the cathode spots 10 are completed. As shown in FIG. 10, each of the cathode bases 11 is electrically coupled to a pair of cathode lines 2 at both ends thereof in the longitudinal directions thereof.

A pair of gates 1a and 1b is disposed by the right-hand and left-hand sides respectively of each of cathode spots 10, and thus sandwiches the cathode spot. Each of the gates 1a and 1b includes a portion parallel to the longitudinal directions of the cathode spot 10 and a gate node 9 whose area is larger than that of the parallel portion thereof. The gate node 9 has an area large enough to have a contact hole 13 which penetrates through the insulating layer 7 and through which the gate branch line 5 is electrically coupled to the gate 1a or 1b. The gates 1a and 1b are coupled to the respective gate branch lines 5, which are joined to the gate line 4, via the respective contact holes 13 at the respective gate nodes 8.

As mentioned above, according to the third embodiment, the gate lines are formed in a layer under the cathode lines so that a wide space can be preserved on the surface of the insulating layer on which a cathode structure is formed. Each of the cathode spots that are juxtaposed is coupled to two cathode lines. Consequently, even if a break occurs at any cathode spot, the break will not affect the other cathode spots.

### Fourth Embodiment

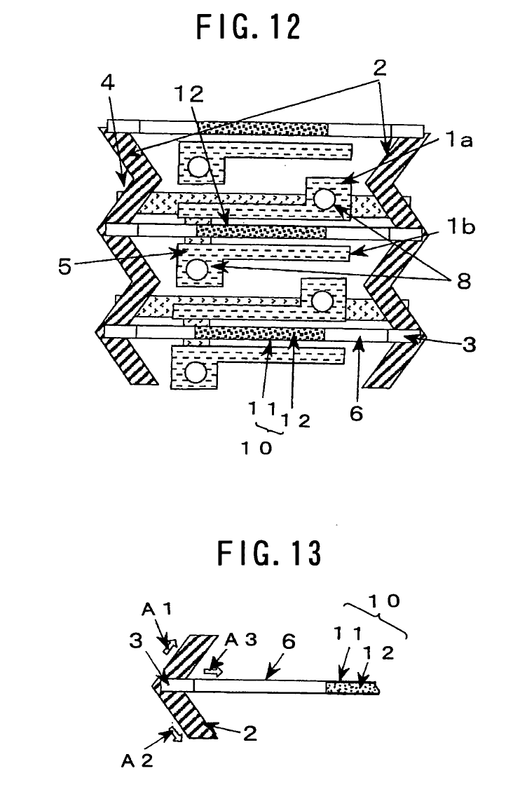

FIG. 12 is a plan view showing a major portion for the purpose of explaining the fourth embodiment of the present invention. FIG. 13 is an explanatory diagram concerning alleviation of stresses imposed on a node among a cathode line and cathode branch lines shown in FIG. 12. In the present embodiment, the present invention is applied to a back substrate having basically the same structure as the structure of the third embodiment. As described previously, according to the method of printing wiring and electrodes by applying a conductive paste such as a silver paste, the conductive paste contracts during a baking process succeeding the printing performed using the conductive paste. In the fourth embodiment, as shown in FIG. 12, the cathode lines 2 are formed in zigzag so that two adjoining cathode lines will have the ridges thereof oriented in opposite directions. Each pair of ridges that produces a wider space is bridged in order to form a cathode spot. Each cathode spot 10 is coupled to each pair of ridges of the cathode lines at cathode nodes 3 via respective cathode branch lines 6 that are joined to the cathode base 11 of the cathode spot 10.

The cathode lines 2, cathode bases 11, and cathode branch lines 6 are printed. When they are baked, contraction occurs. Consequently, tensile stresses that recede from each other as indicated with arrows A1 and A2 in FIG. 13 are developed at each cathode node 3 on a cathode line 2. Consequently, a force displacing the cathode node 3 in a direction indicated with an arrow A3 is exerted. Consequently, even if a cathode base included in a cathode spot contracts, the contraction is alleviated with the displacement of the cathode node 3. Eventually, a break is avoided. Owing to the zigzag structure, a tensile stress induced in each cathode line is also alleviated, and a break of the cathode line is prevented.

The fourth embodiment provides the same advantages as those of the third embodiment. In addition, a break at a cathode spot is suppressed. Moreover, a tensile stress induced in each cathode line is alleviated, and a break of the cathode line is prevented.

### Fifth Embodiment

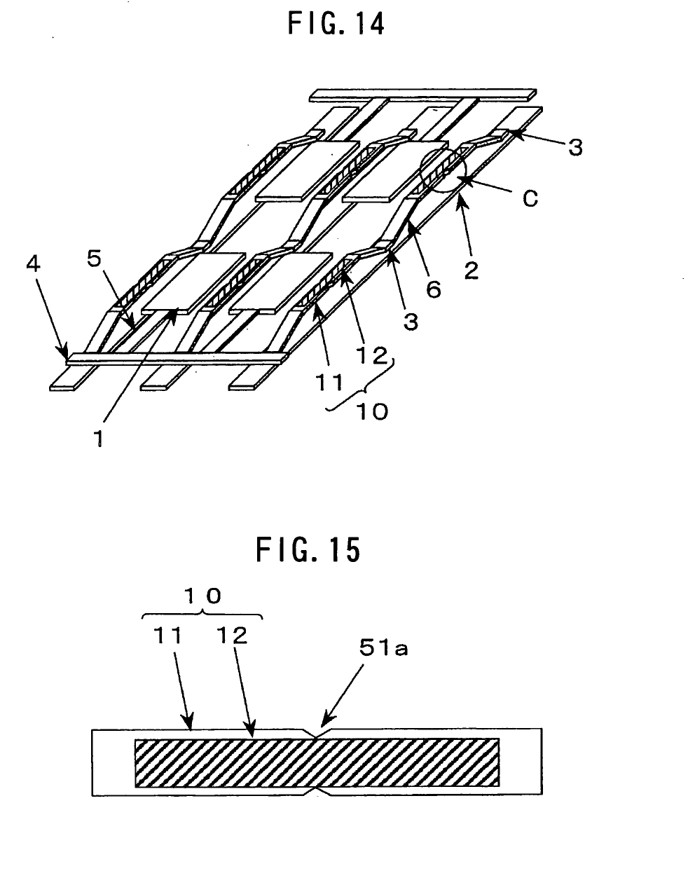

FIG. 14 is a perspective view showing an electron emission structure formed in the main surface of a back substrate for the purpose of explaining the fifth embodiment of the present invention. FIG. 15 is a plan view showing a cathode spot shown in FIG. 14 in enlargement. The fifth embodiment is characterized by a structure of avoiding a break caused by a tensile stress induced in a cathode base included in each cathode spot. In the present embodiment, the present invention is applied to a back substrate included in the second embodiment described in conjunction with FIG. 4 to FIG. 7. The structure can be adapted to the other embodiments in the same manner.

In the fifth embodiment, a cathode base 11 included in each cathode spot 10 has a rupture-prone portion 51a that is more liable to rupture due to tensile stresses than the other portion of the cathode base. The rupture-prone portion 51a has notches formed on both sides of the cathode base 11 on which the electron emission layer 12 is formed.

During baking succeeding printing of cathode bases and others, any of the cathode bases may contract. In this case, tensile stresses derived from the contraction are concentrated on the rupture-prone portion 51a including notches so that the portion will rupture first. According to the fifth embodiment, a rupture can be prevented from occurring in the other portion of the cathode base in which the rupture leads to a fatal defect in movement.

### Sixth Embodiment

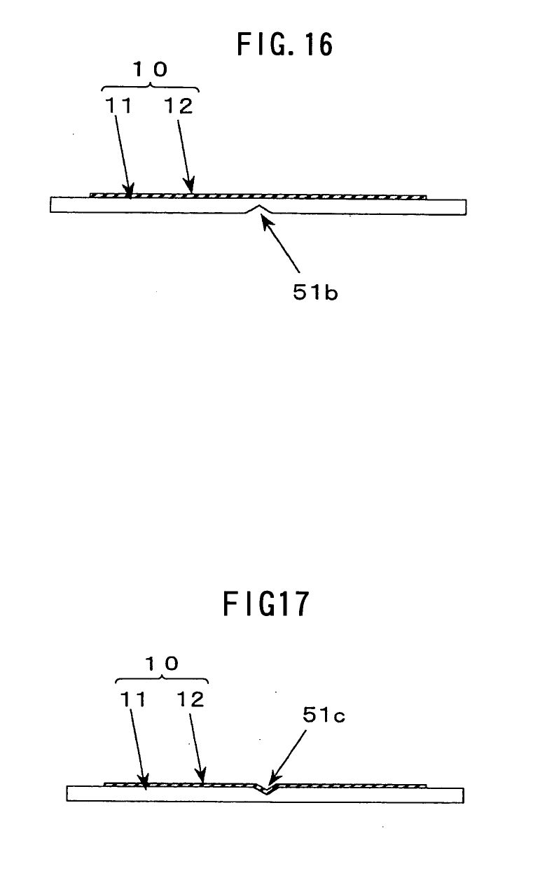

FIG. 16 is a cross-sectional view showing a cathode spot in a back substrate in enlargement for the purpose of explaining the sixth embodiment of the present invention. In the sixth embodiment, a groove extending in the directions of the width of each cathode base 11 is formed in the back of the cathode base 11 included in each cathode spot 10. The portion including the groove is regarded as a rupture-prone portion 51b. In the sixth embodiment, similarly to the fifth embodiment, if each cathode base contracts during baking succeeding the printing of cathode bases and others, tensile stresses derived from the contraction are concentrated on the rupture-prone portion 51b including the groove so that the rupture-prone portions will rupture first. Consequently, a rupture can be prevented from occurring in the other portion of each cathode base where the rupture brings about a fatal defect in movement.

### Seventh Embodiment

FIG. 17 is, similarly to FIG. 16, a cross-sectional view showing a cathode spot in a back substrate in enlargement for the purpose of explaining the seventh embodiment of the present invention. In the seventh embodiment, a groove extending in the directions of the width of each cathode base 11 is formed in the face of the cathode base 11 included in each cathode spot 10. The portion including the groove is regarded as a rupture-prone portion 51c. The electron emission layer 12 is formed to cover even the grooves. Even in the seventh embodiment, similarly to the sixth embodiment, if any of cathode bases contracts during baking succeeding the printing of the cathode bases and others, tensile stresses derived from the contraction are concentrated on the rupture-prone portion 51c including the groove so that the rupture-prone portion will rupture first. Consequently, a rupture can be prevented from occurring in the other portion of each cathode base where the rupture brings about a fatal defect in movement.

### Eighth Embodiment

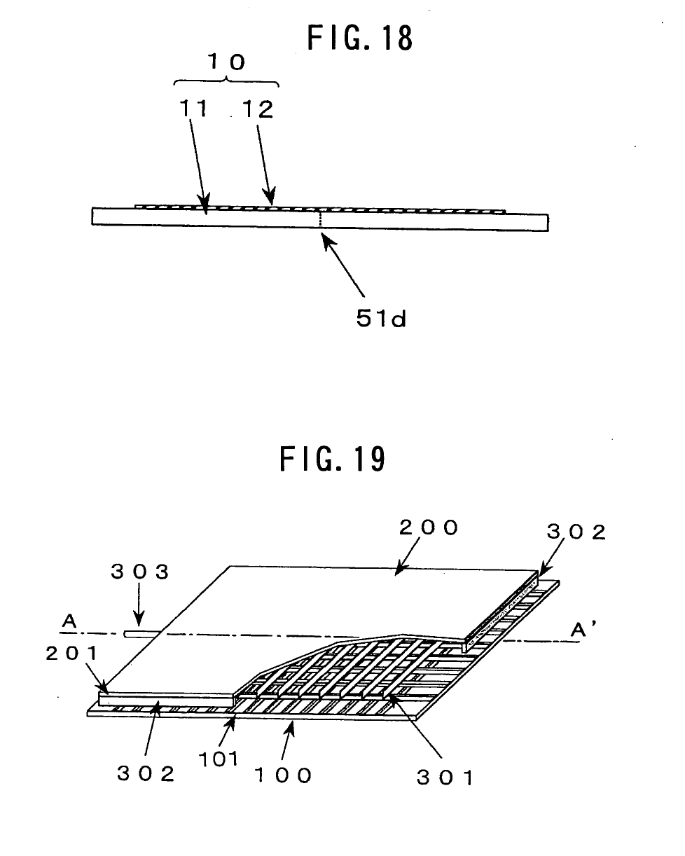

FIG. 18 is, similarly to FIG. 17, a cross-sectional view showing a cathode spot in a back substrate in enlargement for the purpose of explaining the eighth embodiment of the present invention. In the eighth embodiment, a metallic material, whose fusing point is higher than that of the material made into a cathode base 11 included in each cathode spot 10, is used to form a screen. The portion of each cathode spot including the screen is regarded as a rupture-prone portion 51d. The screen that is made of the metallic material having the high fusing point and that serves as the rupture-prone portion 51d is insufficiently sintered at the same temperature as the temperature at which the cathode base is baked. Therefore, the screen portion having the higher fusing point is mechanically feebler than the other portion of each cathode spot. When tensile stresses p are developed, the rupture-prone portion will rupture first. Consequently, a rupture can be prevented from occurring in the other portion of each cathode spot where the rupture will bring about a fatal defect in movement.

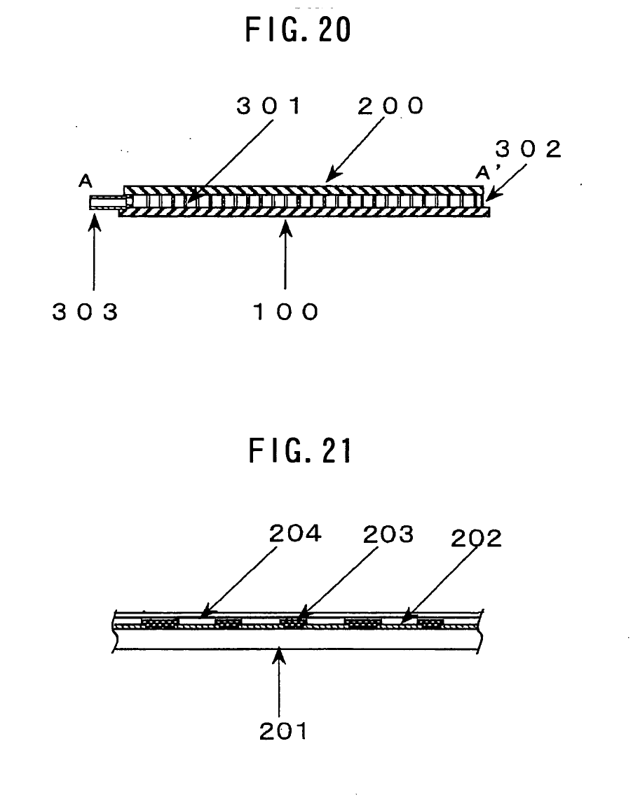

FIG. 19 is a perspective cutaway showing an example of the overall structure of a display device realizing an image display device in accordance with the present invention. FIG. 20 is a cross-sectional view showing an A-A′ cutting plane indicated in FIG. 19. FIG. 21 is a partial cross-sectional view showing an example of the structure of a face substrate. In the image display device, a back panel 100 including a back substrate 101 in which a cathode structure is formed, and a face panel 200 including a face substrate 302 in which phosphor dots and an anode structure are formed, are attached to each other with a sealing frame 302 between the perimeters thereof. Thus, a vacuum container is formed.

Plural spacers 301 are interposed between the substrates in order to restrict a so-called cell gap to a predetermined value. After the vacuum container is deaerated through a vent 303, the vent 303 is fused to seal the vacuum container so that the inside of the vacuum container will be retained at a predetermined degree of vacuum.

FIG. 21 shows the face panel 200 with the main surface of the face panel oriented upward on the page thereof. A black matrix 202, phosphor dots 203, and an anode 204 are sequentially formed on the main surface of the face substrate 201 included in the face panel 200. The phosphor dots 203 are disposed in the form of a matrix so that they will be opposed to cathode spots (pixel locations) formed in the form of a matrix in the back panel 100. The face substrate included in the face panel is normally a transparent glass plate. Moreover, a glass plate or a ceramic is adopted as the back substrate included in the back panel.

As for the face panel 200, after the black matrix 202 is patterned on the face substrate 201, the phosphor dots 203 are formed in the openings of the black matrix 202. A metallic (for example, aluminum) layer is deposited over the phosphor dots in order to form the anode 204. The main surface of the face panel that is the side of the anode 204 is opposed to the main surface of the back panel 100, and bonded with a partition 5 between them. After the internal space of the bonded panels is deaerated through the vent 303, the vent is fused in order to seal the internal space. The phosphor dots are formed at the respective pixel locations. For full-color display, one color pixel is realized with red, green, and blue pixels.

In the above description, the anode 204 is formed on the uppermost layer of the face substrate 201 (on the fluorescent screen). After the anode is formed, the black matrix and fluorescent layer may be formed. However, in this case, a transparent electrode should be adopted as the anode. Moreover, the anode need not be a solid electrode but may have electrodes arranged in the form of stripes in the direction in which scan electrodes or data electrodes are arrayed.

In an image display device including the display panel of any of the present embodiment, when a voltage of 10 kV is applied to the anode and a voltage of 0 V is applied to each of control electrodes and cathode spots, electrons are emitted. When a voltage of −50 V is applied to each of the control electrodes and a voltage of 50 V is applied to each of the cathode spots, the electron emission is ceased. In this state, if a voltage of 0 V is applied to either the control electrodes or cathode spots, the electron emission is ceased. Thus, the so-called matrix operation is accomplished.

The present invention is not limited to the structures described in relation to the respective embodiments. Needless to say, various modifications can be made without a departure from the technological idea of the present invention.

What is claimed is:

1. An image display device including a display device comprising a first substrate and a second substrate and a drive circuit that supplies a display signal to the display device,
wherein the display device comprises:
a first panel that includes the first substrate, one of whose surfaces, that is, whose main surface includes a plurality of electron sources which is arranged in the form of a matrix and each of which comprises a cathode spot that includes an electron emission layer and a cathode base from which electrons are fed to the electron emission layer and a control electrode that is electrically isolated from the cathode spot and that controls the number of electrons to be emitted from the cathode spot, and a plurality of cathode lines and a plurality of control electrode lines over which a plurality of groups into which the cathode spots and control electrodes constituting the respective electron sources are divided is electrically coupled group by group, and that has electrons emitted from an electron source which is designated by selecting one of the cathode lines and one of the control electrode lines; and
a second panel including the second substrate one of whose surfaces, that is, whose main surface includes a plurality of phosphor dots that is arranged in the form of a matrix in association with the array of electron sources and that glows with application of electrons emitted from the electron sources, and an anode that accelerates the electrons,
wherein the main surface of the first panel and the main surface of the second panel are opposed to each other, and the perimeters of the respective main surfaces are attached directly to each other or attached indirectly to each other with a sealing frame between them in order to form a depressurized space between the main surfaces of the respective panels,
wherein each cathode base is electrically coupled to a cathode line having a larger cross-sectional area than the cathode base does, and
wherein each cathode base is connected to the drive circuit with no other cathode base between them.

2. The image display device according to claim 1, wherein the electron emission layer is formed over the surfaces of the cathode bases.

3. The image display device according to claim 1, wherein each cathode base is electrically coupled to a cathode line via a cathode branch line extending from the cathode base.

4. The image display device according to claim 3, wherein each cathode line is wider than each cathode base.

5. The image display device according to claim 3, wherein each cathode base is coupled to a cathode line via a cathode branch line at a plurality of points thereof.

6. The image display device according to claim 5, wherein each cathode base is coupled to a cathode line at both ends thereof.

7. The image display device according to claim 5, wherein a part of each cathode base exhibits less tensile strength than another part thereof and is more liable to rupture.

8. The image display device according to claim 5, wherein a direction of displacement in which each cathode line contracts to be displaced at a node, at which the cathode line meets a cathode base, is substantially identical to a direction of contraction in which the cathode base contracts.

9. The image display device according to claim 1, wherein the cathode bases are made of a sintered granular material.

10. The image display device according to claim 1, wherein the cathode bases are printed.

11. The image display device according to claim 1, wherein the control electrodes and cathode spots are disposed on the same plane parallel to the main surface of the first substrate.

12. The image display device according to claim 1, wherein the cathode bases and control electrodes are formed on the same insulating layer formed on the main surface of the first substrate.

13. The image display device according to claim 1, wherein the main component of the electron emission layer is carbon nanotube, fine carbon fibers, diamond, or a diamond-like carbon.

14. The image display device according to claim 10, wherein a difference between the length of a perpendicular line from a first point, which is an arbitrary point on a cathode spot, to the surface of the anode and the length of a perpendicular line from a second point on a control electrode, which is located closest to the first point on the cathode spot, to the surface of the anode is equal to or smaller than the larger one of the thickness of the cathode spot at the first point and the thickness of the control electrode at the second point.

15. An image display device including a display device comprising a first substrate and a second substrate and a drive circuit that supplies a display signal to the display device,
wherein the display device comprises:
a first panel that includes the first substrate one of whose surfaces, that is, whose main surface includes a plurality of electron sources which is arranged in the form of a matrix and each of which is composed of a cathode spot including an electron emission layer and a cathode base from which electrons are fed to the electron emission layer, and a control electrode that is electrically isolated from the cathode spot and that controls the number of electrons to be emitted from the cathode spot; cathode lines extending in a first direction and juxtaposed in a second direction perpendicular to the first direction, and control lines extending in the second direction and juxtaposed in the first direction, and that has the cathode bases coupled to the cathode lines and has the control electrodes coupled to the control lines; and
a second panel that includes the second substrate one of whose surfaces, that is, whose main surface includes a plurality of phosphor dots which is arranged in the form of a matrix in association with the array of electron sources and which glows with application of electrons emitted from the electron sources, and an anode that accelerates the electrons,
wherein the main surface of the first panel and the main surface of the second panel are opposed to each other, and the perimeters of the main surfaces are attached directly to each other or attached indirectly to each other with a sealing frame between them in order to form a depressurized space between the main surfaces of the respective panels, and
wherein the cathode bases exist independently of the cathode lines.

16. The image display device according to claim 15, wherein the cathode bases are formed in a layer different from the cathode lines, with an insulator between them.

17. The image display device according to claim 15, wherein when the first panel is seen on a planar basis from the side of the main surface thereof, the cathode bases are formed at positions different from the positions of the cathode lines.

18. The image display device according to claim 15, wherein the main component of the electron emission layer is carbon nanotube, fine carbon fibers, diamond, or a diamond-like carbon.

19. The image display device according to claim 15, wherein the width of the cathode bases is smaller than the width of the cathode lines.

20. The image display device according to claim 15, wherein the cathode lines and cathode bases are printed.
